(19) United States
(12) Patent Application Publication
(10) Pub. No.: US 2024/0399321 A1
(43) Pub. Date: Dec. 5, 2024

(54) AN APPARATUS FOR MIXING GASES IN WATER IN THE FORM OF DISSOLVED GAS AND NANOBUBBLES

(71) Applicant: CHUCAO TECHNOLOGY CONSULTANTS SPA, Santiago (CL)

(72) Inventor: José Pablo PUGA TRAVERSO, Llanquihue (CL)

(21) Appl. No.: 18/727,212

(22) PCT Filed: Dec. 29, 2022
(86) PCT No.: PCT/CL2022/050143

§ 371 Date: Jul. 8, 2024

(30) Foreign Application Priority Data
Jan. 12, 2022 (CL) 88-2022

(51) Int. Cl. B01F 23/2373; B01F 23/231

(52) U.S. Cl. CPC B01F 23/2373; B01F 23/231

(57) ABSTRACT

A device for mixing gases in water in the form of dissolved gas and nanobubbles, comprising an external cylindrical housing; a convergent cone type diameter change; a central section of reduced section in a ratio of 1:4 with respect to the inlet and/or outlet sections; a hollow porous cylinder whose thickness is in a ratio of 1:7 with its outer diameter, on which a gas phase is injected through the outer cylindrical face to be mixed with a liquid phase passing through the area delimited by the inner cylindrical face through nanometer-sized pores; a divergent cone-type diameter change; an axially oriented central cylindrical insert in the artifact representing a 30% area restriction of the throat area; turbulence generators arranged in the throat area to generate a field of increased turbulent intensity for turbulent-type bubble breakup.

### STATE OF THE ART

The generation of nanobubbles or ultrafine bubbles is the phenomenon resulting from injecting at least one gas phase into a liquid phase, generating cavities in the latter of sizes smaller than 1 micrometer. Ultrafine bubbles have inherent properties that make them useful in many industrial applications involving multiple phases of the gas-liquid type.

Processes involving multiphase flows are widely used in the agricultural, pharmaceutical, environmental, chemical, and energy sectors. Among these processes, those involving gas and liquid phases are commonly applied in water treatment, aquatic systems restoration, food processing industries, aquaculture, chemical or petrochemical industries, among others. The efficiency of most processes involving multiple gas-liquid phases depends on the operational parameters and design conditions of the equipment involved in these tasks, as well as on the types of contact between phases and the properties of each of the flows. According to the theory of mass transfer from a gas phase to a liquid phase, an increase in the contact area translates into an improvement in the efficiency of the process. In addition, the design of the mixing elements, materials, baffles, spray methods, injection nozzles, and other parameters play an important role either in the heat or mass exchanges or in the contact areas where the phases in contact react.

Regarding the study of bubble behavior, the most frequently studied factors are bubble size, the nature of bubble surface and bubble residence time (Liu, S., Wang, Q., Ma, H., Huang, P., Li, J., & Kikuchi, T. (2010). Effect of micro-bubbles on coagulation flotation process of dyeing wastewater. Separation and purification Technology, 71(3), 337-346). Researchers use bubble size as a basis for categorizing bubbles, as this parameter has been found to differentiate their behavior and properties (Ushikubo, F. Y., Furukawa, T., Nakagawa, R., Enari, M., Makino, Y., Kawagoe, Y., Shiina, T. & Oshita, S. (2010). Evidence of the existence and the stability of nano-bubbles in water. Colloids and Surfaces A: Physicochemical and Engineering Aspects, 361(1-3), 31-37). Based on this, several studies defined bubbles as macrobubbles, microbubbles, and sub microbubbles or nanobubbles, also receiving the names of conventional or large, fine and ultrafine bubbles, respectively (Edzwald, J. K. (2010). Dissolved air flotation and me. Water research, 44(7), 2077-2106; Agarwal, A., Ng, W. J., & Liu, Y. (2011). Principle and applications of microbubble and nanobubble technology for water treatment. Chemosphere, 84(9), 1175-1180; Xu, Q., Nakajima, M., Ichikawa, S., Nakamura, N., & Shiina, T. (2008). A comparative study of microbubble generation by mechanical agitation and sonication. Innovative food science & emerging technologies, 9(4), 489-494; Pérez-Garibay, R., Martinez-Ramos, E., & Rubio, J. (2012). Gas dispersion measurements in microbubble flotation systems. Minerals Engineering, 26, 34-40; Wu, Z., Chen, H., Dong, Y., Mao, H., Sun, J., Chen, S., Craig, V. S., Hu, J. (2008). Cleaning using nanobubbles: Defouling by electrochemical generation of bubbles. Journal of colloid and interface science, 328(1), 10-14; Terasaka, K., Hirabayashi, A., Nishino, T., Fujioka, S., & Kobayashi, D. (2011). Development of microbubble aerator for wastewater treatment using aerobic activated sludge. Chemical engineering science, 66(14), 3172-3179; Ohgaki, K., Khanh, N. Q., Joden, Y., Tsuji, A., & Nakagawa, T. (2010). Physicochemical approach to nanobubble solutions. Chemical Engineering Science, 65(3), 1296-1300; Wu, C., Nesset, K., Masliyah, J., & Xu, Z. (2012) Generation and characterization of submicron size bubbles. Advances in colloid and interface science, 179, 123-132). An upper limit for nanobubbles is set at 1 micron, based on the fact that in that range their behavior and the properties they exhibit are similar and distinct from other classifications (Wu, C., Nesset, K., Masliyah, J., & Xu, Z. (2012). Generation and characterization of submicron size bubbles. Advances in colloid and interface science, 179, 123-132; Temesgen, T., Bui, T. T., Han, M., Kim, T. I., & Park, H. (2017). Micro and nanobubble technologies as a new horizon for water-treatment techniques: A review. Advances in colloid and interface science, 246, 40-51).

The techniques available in the state of the art for generating nanobubbles are: hydrodynamic cavitation and particle cavitation (Agarwal, A., Ng, W. J., & Liu, Y. (2011). Principle and applications of microbubble and nanobubble technology for water treatment. Chemosphere, 84(9), 1175-1180), acoustic techniques (Agarwal, A., Ng, W. J., & Liu, Y. (2011). Principle and applications of microbubble and nanobubble technology for water treatment. Chemosphere, 84(9), 1175-1180; Xu, Q., Nakajima, M., Ichikawa, S., Nakamura, N., & Shiina, T. (2008). A comparative study of microbubble generation by mechanical agitation and sonication. Innovative food science & emerging technologies, 9(4), 489-494; Kim, T. I. (2010). Analysis of bubble potential energy and its application to disinfection and oil washing. Doctorate, Seoul National University) electrochemical cavitation (Wu, Z., Chen, H., Dong, Y., Mao, H., Sun, J., Chen, S., Craig, V. S., Hu, J. (2008). Cleaning using nanobubbles: Defouling by electrochemical generation of bubbles. Journalof colloid and interface science, 328(1), 10-14) and mechanical agitation (Xu, Q., Nakajima, M., Ichikawa, S., Nakamura, N., & Shiina, T. (2008). A comparative study of microbubble generation by mechanical agitation and sonication. Innovative food science & emerging technologies, 9(4), 489-494).

There are several techniques to achieve cavitation by reducing the pressure below a critical value. The most commonly used is based on hydrodynamics, where the pressure variation is achieved by a change of velocity in the fluid, a pressure variation can also be induced by applying an acoustic field, in this case, cavitation occurs when the acoustic wave energy produces periods of high negative pressure that exceed the hydrostatic atmospheric pressure (Besancon, R., The Encyclopedia of Physics. 2013: Springer US), to this end ultrasonic waves are used (Xu, Q., Nakajima, M., Ichikawa, S., Nakamura, N., & Shiina, T. (2008). A comparative study of microbubble generation by mechanical agitation and sonication. Innovative food science & emerging technologies, 9(4), 489-494) either inside the fluid or externally (Li, X., Li, P., Zu, L., Yang, C. (2016) Gas-Liquid Mass Transfer Characteristics with Microbubble Aeration—1. Standard Stirred Tank. Chemical Engineering & Technology, 39(5): p. 945-952). On the other hand, cavitation by energy injection can be induced by photons or other elementary particles (Maoming, F. A. N., Daniel, T. A. O., Honaker, R., & Zhenfu, L. U. O. (2010). Nanobubble generation and its application in froth flotation (part 1): nanobubble generation and its effects on properties of microbubble and millimeter scale bubble solutions. Mining Science and Technology (China), 20(1), 1-19).

Hydrodynamic cavitation is most commonly used in water treatment systems and can be achieved by pressurized saturation, bubble shearing, breaking and mechanical agitation (Liu, S., Wang, Q., Ma, H., Huang, P., Li, J., & Kikuchi, T. (2010). Effect of micro-bubbles on coagulation flotation process of dyeing wastewater. Separation and purification Technology, 71(3), 337-346; Ushikubo, F. Y., Furukawa, T., Nakagawa, R., Enari, M., Makino, Y., Kawagoe, Y., Shiina, T. & Oshita, S. (2010). Evidence of the existence and the stability of nano-bubbles in water. Colloids and Surfaces A: Physicochemical and Engineering Aspects, 361(1-3), 31-37; Terasaka, K., Hirabayashi, A., Nishino, T., Fujioka, S., & Kobayashi, D. (2011). Development of microbubble aerator for wastewater treatment using aerobic activated sludge. Chemical engineering science, 66(14), 3172-3179; Ohgaki, K., Khanh, N. Q., Joden, Y., Tsuji, A., & Nakagawa, T. (2010). Physicochemical approach to nanobubble solutions. Chemical Engineering Science, 65(3), 1296-1300; Ebina, K., Shi, K., Hirao, M., Hashimoto, J., Kawato, Y., Kaneshiro, S., Morimoto, T., Koizumi, K., Yoshikawa, H. (2013) Oxygen and Air Nanobubble Water Solution Promote the Growth of Plants, Fishes, and Mice. PLoS ONE, 8(6): p. e65339; Li, X., Li, P., Zu, L., Yang, C. (2016) Gas-Liquid Mass Transfer Characteristics with Microbubble Aeration—I. Standard Stirred Tank. Chemical Engineering & Technology, 39(5): p. 945-952; Kim, H., & Han, M. (2014) A study on the development of sub-micron bubble generator and characterization of sub-micron bubble, in Civil and Environmental Engineering Department, Seoul National University p. 133; AWWA, A.W.W.A., Water quality and Treatment. 5th ed. 1999, United States of America: McGraw-Hill. 1163; Kim, T. I. (2010). Analysis of bubble potential energy and its application to disinfection and oil washing. Doctorate thesis, Seoul National University). Wu et al. (2012) discusses some methods of fine bubble generation by hydrodynamic cavitation (swirl flow, Venturi type, ejector type, pressurized dissolution type) which use hydrodynamic cavitation mechanisms that achieve pressure reduction under vapor pressure due to high velocities (Wu, C., Nesset, K., Masliyah, J., & Xu, Z. (2012). Generation and characterization of submicron size bubbles. Advances in colloid and interface science, 179, 123-132). On the other hand, a hydrodynamic bubble separator employs shear stresses to the bubbles and, additionally, cavitation to reduce the size thereof (Kim, H., & Han, M. (2014) A study on the development of sub-micron bubble generator and characterization of sub-micron bubble, in Civil and Environmental Engineering Department, Seoul National University p. 133).

Electrochemical methods employ an electric current on a surface which is immersed in the solution to generate bubbles by nucleation on the surface (Wu, Z., Chen, H., Dong, Y., Mao, H., Sun, J., Chen, S., Craig, V. S., Hu, J. (2008). Cleaning using nanobubbles: Defouling by electrochemical generation of bubbles. Journal of colloid and interface science, 328(1), 10-14). Mechanical cavitation employs high agitation speeds using mechanical stirrers in a volume of liquid with a limited amount of gas (Wu, C., Nesset, K., Masliyah, J., & Xu, Z. (2012). Generation and characterization of submicron size bubbles. Advances in colloid and interface science, 179, 123-132), this technique applies the same principles as hydrodynamic cavitation.

The role of turbulence in bubble breakup is key and was first studied by Hinze in 1955, who described that the kinetic energy of turbulent motion of one continuous phase results in the breakup of the second phase (Hinze, J. O. (1995). Fundamentals of the hydrodynamic mechanism of splitting in dispersion processes. AIChE Journal. 1(3):289-295). Bubble breakup is related to the critical Weber number, which is defined as the ratio of the turbulent force to the surface tension force. Thus, an increase in turbulence intensity will increase the turbulent force resulting in smaller bubbles (Li, J., Song, Y., Yin, J., & Wang, D. (2017). Investigation on the effect of geometrical parameters on the performance of a Venturi type bubble generator. Nuclear Engineering and Design, 325, 90-96), which is desirable in a nanobubble generator as with smaller bubble size the volumetric bubble density also increases. The bubble size distribution along with the interfacial area concentration is determined by turbulent flow characteristics (Kocamustafaogullari, G., Ishii, M., 1995. Foundation of the interfacial area transport equation and its closure relations. International Journal of Heat and Mass Transfer 38, 481-493). Indeed, Serizawa (2017) studies different geometrical parameters in a Venturi type bubble generator, such as: number of air injections, diameter of air injections, and angle of the divergent area, concluding that the bubble size distribution is highly sensitive to the angle of the divergent area and that the higher the divergent angle, the higher the turbulent intensity and turbulent force, which results in a gain of smaller size bubbles (Serizawa, A (2017). Fundamentals and applications of micro/nano bubbles. Kyoto University, Japan).

Turbulence generators increase turbulent intensity in specific areas, and have been widely studied and used in various applications, such as in aerodynamics (Lu, F., Li, Q., Shih, Y., Pierce, A., & Liu, C. (2011). Review of micro vortex generators in high-speed flow. In 49th AIAA aerospace sciences meeting including the new horizons forum and aerospace exposition, p. 31; Titchener, N., & Babinsky, H. (2015). A review of the use of vortex generators for mitigating shock-induced separation. Shock Waves, 25(5), 473-494) heat transfer (Chai, L., & Tassou, S. A. (2018). A review of airside heat transfer augmentation with vortex generators on heat transfer surface. Energies, 11(10), 2737) collection of fine particulate matter (Sun, Z., Yang, L., Chen, S., and Wu X. (2020) Promoting the Removal of Fine Particles by Turbulent Agglomeration with the Coupling of Different-Scale Vortexes. Powder Technology 367:399-410), among others. These manipulate the circulation of a fluid by increasing its turbulence, generating vortices and/or re-energizing the flow in specific recirculation areas, achieving improvements in terms of aerodynamic efficiency (Lu, F., Li, Q., Shih, Y., Pierce, A., & Liu, C. (2011). Review of micro vortex generators in high-speed flow. In 49th AIAA aerospace sciences meeting including the new horizons forum and aerospace exposition, p. 31; Titchener, N., & Babinsky, H. (2015). A review of the use of vortex generators for mitigating shock-induced separation. Shock Waves, 25(5), 473-494) or increased heat transfer (Chai, L., & Tassou, S. A. (2018). A review of airside heat transfer augmentation with vortex generators on heat transfer surface. Energies, 11(10), 2737). Their geometry may be small in size with respect to the equipment, machine, or vehicle in which they are used, however, their effect on the fluid is somewhat complex and requires detailed experimental or numerical studies (Titchener, N., & Babinsky, H. (2015). A review of the use of vortex generators for mitigating shock-induced separation. Shock Waves, 25(5), 473-494). Some types of turbulence generators are wedge type, vane type, wishbone type, doublet type wheeler vanes, Z or cross type, plate type, delta type, semicircular type, triangular type, dimple type, etc.

At present, there are several types of fine and ultrafine bubble generators with different characteristics and performance levels. The main types of fine and ultrafine bubble generator equipment are described below:
a. Venturi-type generators: A liquid flow and an air flow pass through the inlet of a Venturi tube. When both phases reach the throat of the Venturi tube, the flow is accelerated which causes a rapid change in the dynamic pressure, which promotes the formation of micro and nanobubbles by reduction of the gas phase.
b. Ejector-type generators: The generator has channels that shrink and expand producing a complex pressure profile. The gas phase is sucked from the lowest pressure point and the gas flow is transformed into fine bubbles by the action of shear forces.
c. Pressurized dissolution-type generators: A mixture of liquid and gas is pressurized in a tank where the gas is dissolved to saturation concentration. Micro bubbles are generated by expelling the saturated liquid into the liquid phase through a reducing valve. The size of the bubbles generated depends on the pressure of the pressurized tank.
d. Generation by depressurization: It is based on homogeneous/heterogeneous nucleation and cavitation through sudden depressurization of the system. It is possible to obtain a high bubble density with the use of a high pressure pump.
e. Generation by swirl flow: The gas-liquid mixture is introduced tangentially into a vessel forming a swirl flow inside. The swirl induces negative pressure along the centerline of the vessel, which can suck in the gas phase. The gas phase is separated into fine bubbles at one end of the vessel by the strong shear stresses of the high velocity swirl flow escaping from the vessel. Its manufacture is of low cost and complexity, also obtaining a low bubble density.
f. Generation by static mixer: A structure is designed to guide the flow so that it reaches high speed and swirls. A strong shear field is formed by the interactions between the swirl flow and the current cutters. Negative pressure is achieved in the central area of the cylinder and in the regions behind of the current cutters. Fine bubbles are generated by a combination of nucleation, cavitation, and shear force by shockwaves. A high-pressure pump is used for this purpose.
g. Generation by injection of gases through a porous medium: The gas phase is injected through a material with ultra-fine pores, where a moving liquid interrupts the gas phase resulting in the generation of ultra-fine bubbles. Ceramic or carbon-ceramic materials having nano pores are used.
h. Generation by hydrodynamic cavitation: The design of this equipment includes geometric features that cause sudden pressure changes in the liquid, the sudden pressure drops under the vapor pressure thereof generate cavities where the fluid changes phase generating nanobubbles.
i. Shear stress generation: Bubbles are generated because the liquid mixed with the gas phase is exposed to high shear gradients in its different layers.

There are patents for devices for the generation of nanobubbles. Such as:
1. Moleaer, which uses a combination of principles g) and i), wherein the bubbles are generated in a porous medium (which in their claims indicate have a porosity of less than 1 micrometer). It is understood that this requires gas pressures above 6 bar, which is not feasible in many applications. Also, in practice, their equipment has pressure drops in the order of 1.5 bar.
2. Gaia, which uses principle i), including a static mixer, used for decades, requires low pressures, but achieves nano bubble concentrations of less than 100 million per milliliter.

Thus, the main constraint for industrial nanobubble generators is a combination of optimal energy consumption (low pressure drop), high efficiency in mass transfer, and high volumetric density of nanobubbles plus compatibility in use with liquids containing foreign particles.

It is known that generators employing swirl flow, ejector, Venturi, and pressure dissolution-type mechanisms show gas transfer efficiency close to or higher than 65%. On the other hand, those using swirl flow or ejector-type mechanisms are not compatible with liquids containing foreign particles. In addition, most of the generation mechanisms require the use of a high pressure pump in their liquid and/or gas phases.

Therefore, there is still a need to develop a device for mixing gases in a liquid phase in the form of nanobubbles, with low energy consumption and high efficiency in mass transfer, compatible with liquids that may contain particles. Where the turbulent interaction of the phases and their role and interaction with the generation of nanobubbles is also known in detail.

### BRIEF DESCRIPTION OF THE FIGURES

FIG. 1: Comparison of original and new geometric models.

FIG. 2: Geometry of the nano bubble generator in isometric view.

FIG. 3: Geometry of the nano bubble generator in top view and in cross section.

FIG. 4: Comparison of results obtained by CFD modeling, specifically static pressure distribution in two planes, vertical and horizontal, of the original and optimized equipment.

FIG. 5: Comparison of results obtained using CFD modeling, specifically distribution of the fluid velocity magnitude in two planes, vertical and horizontal, of the original and optimized equipment.

FIG. 6: Comparison of results obtained using CFD modeling, specifically static pressure distribution over different axial positions of the apparatus.

FIG. 7: Comparison of results obtained using CFD modeling, specifically turbulence intensity distribution over horizontal and vertical planes of the apparatus.

### DESCRIPTION OF THE INVENTION

The invention corresponds to an apparatus for mixing gases in water in the form of dissolved gas and nanobubbles, useful in industrial processes that work with multiple liquid-gas type phases (see FIG. 2). The device allows dissolving gas in water by generating nanometric bubbles by injecting gas through a porous medium in an area where suction is induced by the hydrodynamic conditions of the equipment, i.e., it does not require pressurization of the gas phase. The device has been optimized to minimize pressure drop in the liquid phase. Additionally, the device reduces the size of bubbles leaving the porous medium due to the bubble breakup by the turbulent shear flow field produced by an array of turbulence generators.

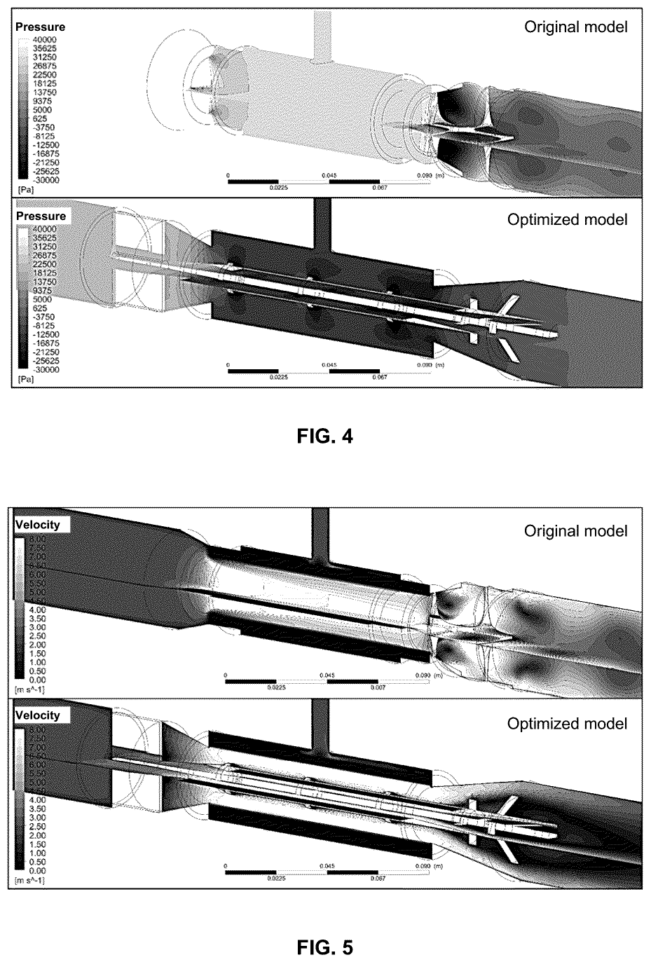

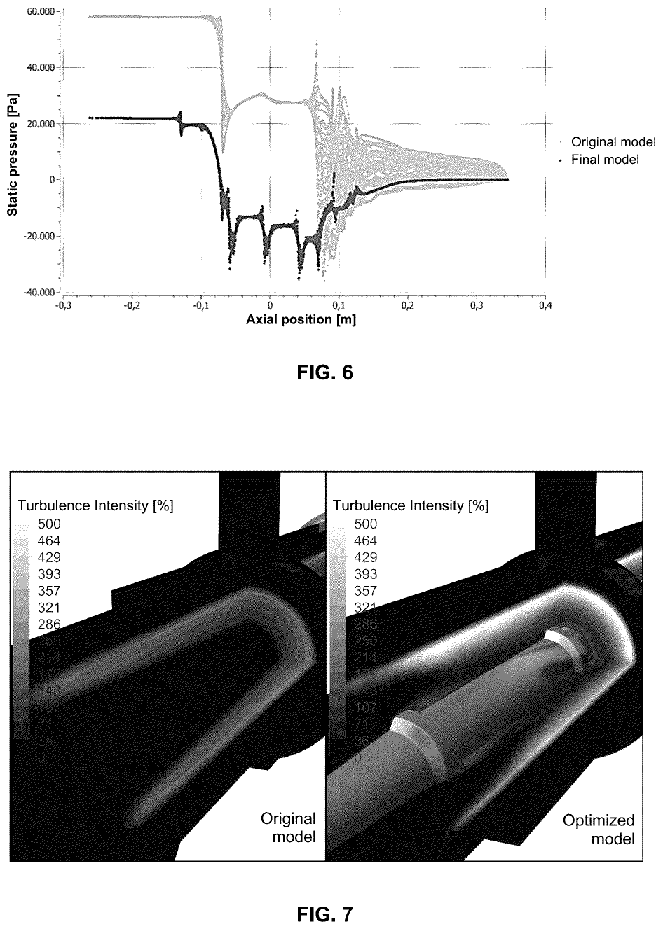

The geometrical characteristics of the nanobubble generator allow it to function as a Venturi tube for the liquid phase, since the flow of fluid through the apparatus is reduced in the central section or throat and then returns to a wider cross section. The reduction in area in the throat area has a ratio of 1:4 compared to the inlet area. The cross-sectional changes are progressive and smooth in order to increase the water velocity from an inlet value of 2.1 [m/s] to an average velocity in the throat area of 8.24 [m/s] (see FIG. 5). The flow acceleration described above has an important effect on the pressure in the central area of the apparatus, since it reduces the static gauge pressure to values between −13 [kPa] to −19 [kPa] (see FIG. 6) in the throat area, that is, specifically in the inner area of the porous tube (throat), in its full thickness, in the recess of the outer housing and in the inlet area of the gas phase, making external pressurization of the gas phase dispensable (see FIG. 4). The nanobubble generator includes 5 turbulence generators that interact with the multiphase flow (see FIG. 7).

The gas phase enters by suction due to the Venturi tube type design, and then surrounds the porous tube on its external cylindrical face in a cavity designed so that it can be distributed uniformly. From there it enters the throat area of the apparatus by the effect of suction through the pores of the tube. When the gas phase crosses the porous tube radially inward, it meets the liquid phase that is circulating axially, so the liquid phase detaches the gas phase that is being discharged through the micrometer pores of the porous medium. In the inner area adjacent to the interface between the inner face of the porous medium and the multiphase flow, oxygen microjet breakup is generated by the shear effect generated by the turbulent shear flow field.

In the throat area of the equipment, there is a central axial cylindrical insert having a diameter change of 1:2 ratio, the cylindrical insert represents a blockage ratio of 28% with respect to the total area of the throat area. A total of 5 turbulence generators of 3 types are installed on this insert; a type A (11) having the shape of a rhomboid of revolution with sides inclined at 45°, wherein the ratio between height and length is 1:1, and the ratio between their height and the diameter of the cylindrical insert (7) where it is mounted is 1:9; a type B (12) is in the form of a hollow cylinder, wherein the ratio between height and length is 1:1, and the ratio between its height and the diameter of the cylindrical insert (7) where it is mounted is 1:2; and a type C (12) having the shape of a rhomboid of revolution with sides inclined at 45°, wherein the ratio between height and length is 2:1, and the ratio between its height and the diameter of the cylindrical insert (7) where it is mounted is 1:1. In this way, the cylindrical insert and the turbulence generators increase the local shear stress by increasing the velocity and turbulence intensity of the flow and directing it towards the inner cylindrical wall of the porous tube.

Downstream of the throat area, the housing recovers the initial cross section at its outlet point. The design of the equipment in this area maintains a high turbulence intensity which promotes the breakup of microbubbles, but avoids the generation of recirculation and sudden diameter reductions, resulting in a low pressure drop with respect to conventional nanobubble generators.

The generator consists of an external housing (1) that includes: a water inlet (2), a gas inlet (3), a water outlet with presence of nanobubbles (4), a cylindrical recess (5) to distribute the gas uniformly around a porous tube (7), a divergent cone whose angle is 20° (6). In addition, a porous tube with porosity between 30 and 37% and a pore size of 0.45 [μm] (7) is located in the central area of the housing; next to it, towards the water inlet area, there is a convergent cone with an angle of 30° (8). An axial cylindrical insert with diameter change (9) is located along a large portion of the equipment, held by two supports (10) located near the water inlet (2) and the water outlet with nanobubbles (4). On the cylindrical insert (9), three type A turbulence generators (11), one type B turbulence generator (12) and one type C turbulence generator (13) are installed.

The outer housing (1) has a ratio of 1:7 between its inner diameter and length. It has a cylindrical shape on the outside and the inside includes the following features; support to locate and center the porous tube (7); space to evenly distribute the gas phase (5); 20° divergent cone (6) at the outlet of the central or throat section of the apparatus; diameter change that houses the convergent cone (8).

The hollow cylinder-shaped porous tube (7) has a ratio of 1:4 between its outer diameter and length, while its thickness and outer diameter are in a ratio of 1:7. It is supported and centered by the outer housing (1) and is also supported by a section of the convergent cone (8).

The convergent cone (8) has an angle of inclination of 30° to allow a progressive and gradual entry into the central or throat area of the equipment. It is located in a diameter change of the external housing (1) and also allows to support and center the porous tube (7).

The cylindrical insert (9) is arranged axially inside the apparatus covering 90% of the length of the apparatus. Towards the flow inlet area (2), it has a diameter reduced in a 1:2 ratio to support the thinner end on a support (10) with minimum impact to the fluid. On the cylindrical insert, specifically in the throat area, 3 type A turbulence generators (11) are located, separated at a distance equivalent to 5 diameters of the insert, then in the divergent area, one type B turbulence generator (12) and one type C turbulence generator (13) are located, towards the fluid outlet (4) another support is provided with a support (10) placed on the thicker end of the cylindrical insert (9).

### APPLICATION EXAMPLES

### Example 1. Optimization of a Nanobubble Generator Device by Means of Computational Simulation of Fluid Dynamics

It is important to note that the equipment to be optimized (Quetrox) has been tested as a prototype capable of generating a high volumetric concentration of nanobubbles (greater than 200 million per milliliter, according to NanoSight of Universidad de Chile) with a relatively low pressure drop of less than 1 [bar].

In order to obtain operational advantages with a new nanobubble generator design, simulations were performed using Computational Fluid Dynamics (CFD). Through this methodology, it is possible to simulate multiphase flow dynamics, which allows the evaluation of multiple configurations and operating parameters.

Through the application of this methodology, it was possible to determine the impact on the performance of design characteristics of the proposed equipment, among which those with a hydrodynamic impact on the increase of turbulence intensity, shear flow, and decrease of pressure loss stand out.

In a first stage, the simulation of the original Quetrox equipment was carried out, which was the base model for the optimization. The pressure drop of the equipment was determined as well as the pressure fields, velocity, turbulence intensity, shear stresses, among others.

Regarding the submodels used for the simulation, the second order turbulence model κ—ω̅ SST was selected, which is capable of describing complex swirl flows, such as those that occur in recirculation and mixing areas in equipment that work with liquid-gas phases. In addition, the SIMPLE scheme was used for pressure-velocity coupling; the least squares method was configured in each cell to calculate the gradient and a second order method was used to determine the pressure at the reactor outlet.

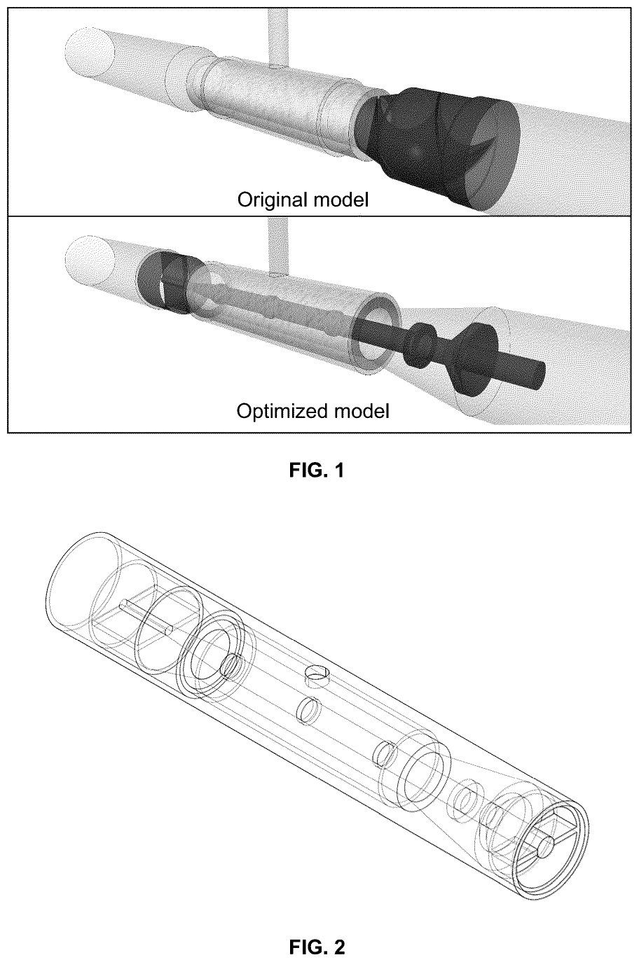

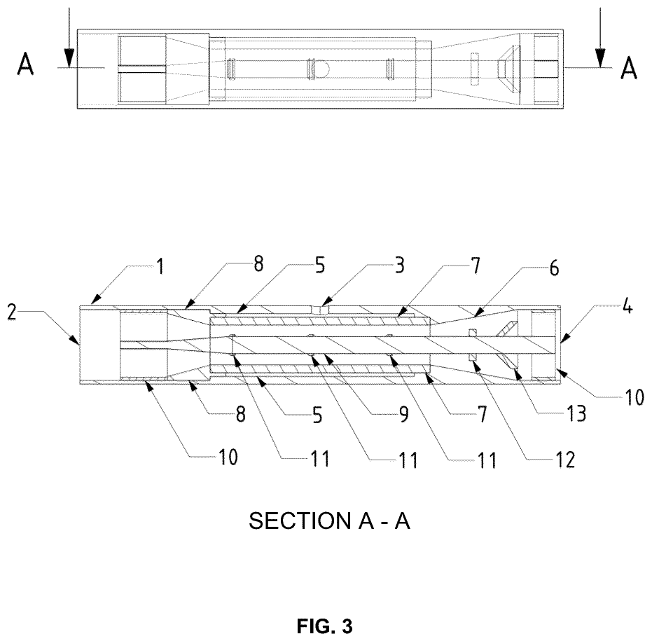

Based on the results obtained, together with design and/or manufacturing requirements, geometric modifications are generated to improve the hydrodynamic performance of the equipment. The geometrical modifications are presented in FIG. 1. These were implemented to the original model pursuing the following objectives:
Reducing the pressure losses that are not employed in the generation of nanobubbles.
Increasing shear by the shear flow.
Increasing turbulence intensity.

The main results obtained by CFD simulation are summarized in Table 1:

TABLE 1
Summary of results obtained for the new and original model:

| | New or | Base or | |
|---|---|---|---|
| | optimized | original | Difference |
| Parameter | model | model | [%] |
| Pressure drop [bar] | 0.583 | 0.221 | −62 |
| Average velocity in | 6.76 | 8.24 | +22 |
| throat area [m/s] | | | |
| Average turbulence intensity | 114 | 147 | +29 |
| in the throat area [%] | | | |
| Maximum turbulence intensity | 160 | 530 | +330 |
| in throat area [%] | | | |

The results obtained allowed replicating the operating conditions of the models evaluated to determine the dynamics of the fluids in the generator. It was concluded that the improvements estimated in the design phase did result in a significant improvement at the hydrodynamic level, since they allowed reducing to almost one third the pressure loss of the apparatus (see FIG. 6). In addition, it was shown that the geometrical modifications achieved a suction effect for the gas phase, which provides an additional operational advantage to the apparatus (see FIG. 4).

From a nanobubble generation point of view, the geometrical modifications allowed; increasing the shear stresses in the gas injection area, improved the velocity distribution in the gas injection area (see FIG. 5), and increased the turbulent intensity in that area to assist in bubble breakup (see FIG. 7). The increased turbulent intensity is a particularly useful effect for obtaining gains in smaller bubble size than the original model along with higher volumetric bubble density, FIG. 7 shows the increased turbulence intensity of the new design.

1. A device for the injection of gases into water in the form of nanobubbles comprising at least one external cylindrical housing (1);
with a liquid inlet (2), a gas inlet (3), a cylindrical area (5) for uniformly distributing a gas phase, a fluid outlet (4), a divergent conical diameter change (6) having an inclination of 20°; a convergent cone (8) having an inclination of 300 forming a throat area; a porous tube (7); a cylindrical insert (9) having a diameter change in a ratio of 1:2; two clamping elements (10) of the cylindrical insert (9); three turbulence generators (11) located in the throat area; and two turbulence generators (12, 13) located in the divergent area of the device.

2. (canceled)

3. (canceled)

4. The device for the injection of gases into water in the form of nanobubbles, according to claim 1, wherein the porous tube (7) is hollow cylinder-shaped and has an inner area that radially delimits the throat area of the device, while the limits at the porous tube (7) ends are the convergent cone (8) and the divergent cone (6).

5. The device for the injection of gases into water in the form of nanobubbles, according to claim 1, wherein the porous tube (7) is hollow cylinder-shaped and allows the injection of the gas phase into the liquid phase through its cavities, the circulation being of radial type with direction towards the center of the throat area of the device.

6. The device for the injection of gases into water in the form of nanobubbles, according to claim 1, wherein the convergent cone (8) having an inclination of 30° involves a change of section in a ratio of 5:2.

7. The device for the injection of gases into water in the form of nanobubbles, according to claim 1, wherein the diverging cone (6) having an inclination of 200 involves a change of section in a ratio of 1:3.

8. The device for the injection of gases into water in the form of nanobubbles, according to claim 1, wherein the cylindrical insert (9) is axial, has a diameter change in a ratio of 1:2 and represents a cross-sectional blockage of the throat area of 28%.

9. The device for the injection of gases into water in the form of nanobubbles, according to claim 1, wherein the three turbulence generators (11) have a shape of a rhomboid of revolution with sides inclined at 45°, a ratio between height and length is 1:1, and a ratio between their height and the diameter of the cylindrical insert (7) where it is mounted is 1:9.

10. The device for the injection of gases into water in the form of nanobubbles, according to claim 1, wherein the turbulence generator (12) is in the form of a hollow cylinder, and a ratio between height and length is 1:1, and a ratio between its height and the diameter of the cylindrical insert (7) where it is mounted is 1:2.

11. The device for the injection of gases into water in the form of nanobubbles, according to claim 1, wherein the turbulence generator (13) has a shape of a rhomboid of revolution with sides inclined at 45°, a ratio between height and length is 2:1, and a ratio between its height and the diameter of the cylindrical insert (7) where it is mounted is 1:1.
